(19) United States
(12) Patent Application Publication
(10) Pub. No.: US 2015/0127253 A1
(43) Pub. Date: May 7, 2015

(54) Mileage Tracker

(71) Applicant: Ney Jose Torres Hurtado, Glendale, AZ (US)

(72) Inventors: Ney Jose Torres Hurtado, Glendale, AZ (US); Raymond S. Embry, III, Gilbert, AZ (US)

(73) Assignee: Ney Jose Torres Hurtado, Glendale, AZ (US)

(21) Appl. No.: 14/170,908

(22) Filed: Feb. 3, 2014

Related U.S. Application Data
(60) Provisional application No. 61/900,400, filed on Nov. 6, 2013.

(51) Int. Cl. G07C 5/08

(52) U.S. Cl. CPC G07C 5/0858
USPC 701/527

(57) ABSTRACT

A mobile device for tracking mileage, including a software mobile application (“app”) that launches a service, which permits relatively uninterrupted tracking of mileage even during incoming telephone calls to the mobile device.

### CROSS REFERENCE TO RELATED APPLICATIONS

This application claims the benefit of U.S. provisional patent application Ser. No. 61/900,400, filed 2013 Nov. 6, by Torres, having the title “The Tax GPS,” which is incorporated herein by reference in its entirety.

### BACKGROUND

1. Field of the Disclosure

The present disclosure relates generally to programmable systems and, more particularly, to mobile programmable systems.

2. Description of Related Art

Mobile devices (e.g., smartphones, tablets, etc.), continue to increase their functionality. As more streamlined and robust operating systems develop for the smartphones, more and more applications are being written for a variety of functions. These applications continue to evolve as smartphones become increasingly compatible with other programmable systems.

### SUMMARY

The present disclosure provides systems and methods for tracking mileage on a vehicle by a mobile device. The mobile device includes a software application that launches a service, thereby permitting relatively uninterrupted tracking of mileage even during incoming telephone calls (or other operating-system-initiated interruptions) to the mobile device.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A through 1D (collectively, FIG. 1) are flowcharts showing one embodiment of a process for tracking mileage using a mobile device.

FIG. 2 is a block diagram showing one embodiment of a data processing system of an embodiment of a mobile device.

### DETAILED DESCRIPTION OF THE EMBODIMENTS

Due to the demand for faster performance with less memory usage, streamlined and robust operating systems (or lighter operating systems) are continuing to evolve for mobile devices (e.g., smartphones, tablets, etc.). As these operating systems become lighter (e.g., occupy less storage and memory, launch applications faster, etc.), mobile computing platforms now permit launching of multiple mobile applications (or “apps”) on the same device.

Recently, one development for mobile devices has been to integrate smartphones (or other hand-held devices) with vehicle on-board diagnostics (OBD) so that the mobile device can gather data from the OBD and analyze that data for different purposes. The available data from the OBD includes information, such as, for example, fuel system status, engine coolant temperature, fuel-air mixture sensor readings, intake manifold pressure, vehicle speed, throttle position, engine revolutions-per-minute (“RPM”), air flow rate, intake air temperature, oxygen sensor readings, runtime since engine start, distance traveled since engine start, fuel rail pressure, fuel level, distance traveled since code cleared, barometric pressure, relative throttle position, ambient air temperature, relative accelerator pedal position, battery pack remaining life, engine oil temperature, fuel injector timing, engine fuel rate, engine reference torque, and almost every other vehicle-systems-related data.

Given the richness of the available data from the OBD, others have attempted to write mobile computing applications (or apps) to track driver behavior, fuel consumption, and vehicle mileage. Insofar as Apple® operating systems and Android™ operating systems account for a majority of the operating systems in mobile devices in the market, a vast majority of the apps are developed on these two mobile platforms. These and other operating systems (e.g., BlackBerry™, Windows® Mobile, etc.) control the function and operation of smartphones and other cellular devices that permit incoming and outgoing telephone calls.

Due to the lightweight nature of these operating systems, smartphones do not permit multi-tasking as is done on desktop computers or other non-mobile platforms. Rather, apps can spawn threads to perform background processes, such as uploading files, thereby preventing the user interface (“UA”) from freezing or being otherwise disabled while the background process continues.

There are, however, one or more events that cause a complete termination of an app. For example, the operating system (“OS”) prioritizes memory usage, battery power, and telephone calls above other apps. Thus, for example, if an Android™-based smartphone detects an incoming telephone call, which has precedence over most other apps, then the smartphone will normally pause the other lower-priority apps that are being executed on the smartphone to allow the incoming telephone call. Thus, for example, an incoming telephone call will take precedence over a conventional vehicle mileage tracking app. Consequently, if an operator is tracking the mileage of a vehicle using a conventional app on a smartphone, then an incoming telephone call (or other similar interrupt event) will result in the conventional mileage tracking app being paused. The pausing of the app results in a loss of the data connection (e.g., loss of Bluetooth® connection) and a resulting loss of data or inaccurate logging of data, which becomes problematic when accurate tracking of vehicle mileage is needed.

To overcome this shortcoming, the systems and processes described herein provide a mechanism by which mileage can be tracked on a mobile device even during an incoming telephone call (or other similar interrupt event). In other words, the disclosed smartphone and its corresponding app permits continued tracking of mileage, thereby ameliorating the shortcomings of conventional apps that are terminated due to an incoming telephone call or other similar interrupt event. Specifically, the disclosed embodiments permit the mileage-tracking app to launch a service that continues uninterrupted during a telephone call or other similar event.

Having provided an overview of a mobile device that permits relatively uninterrupted tracking of vehicle mileage, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

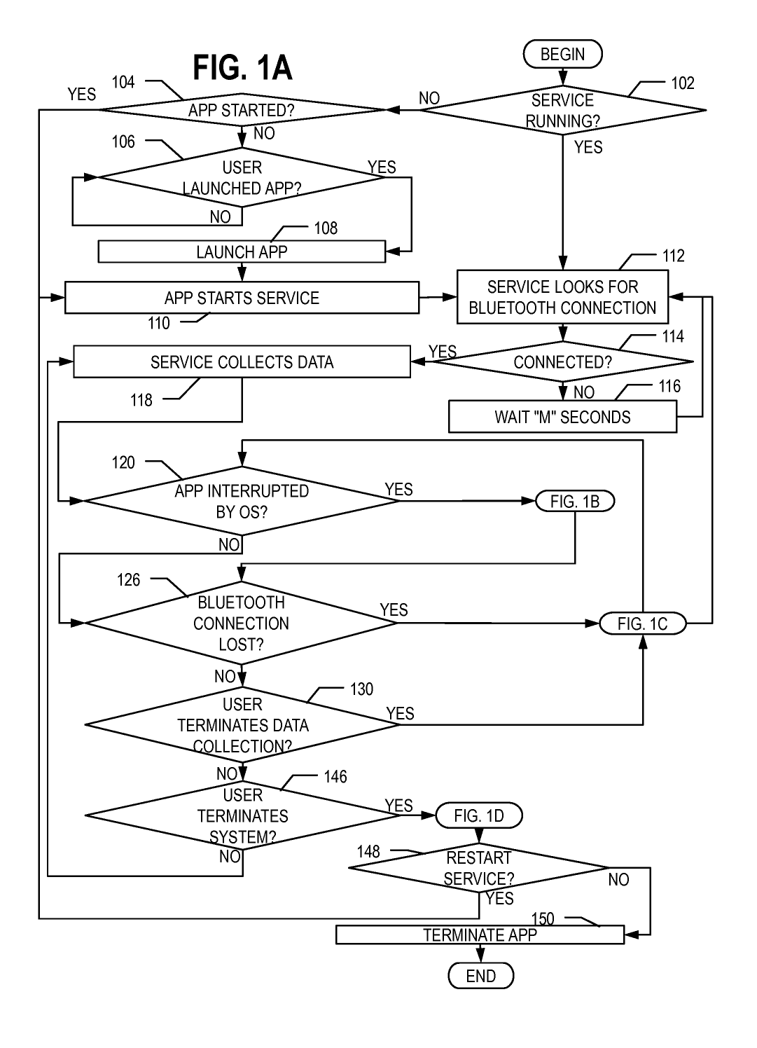

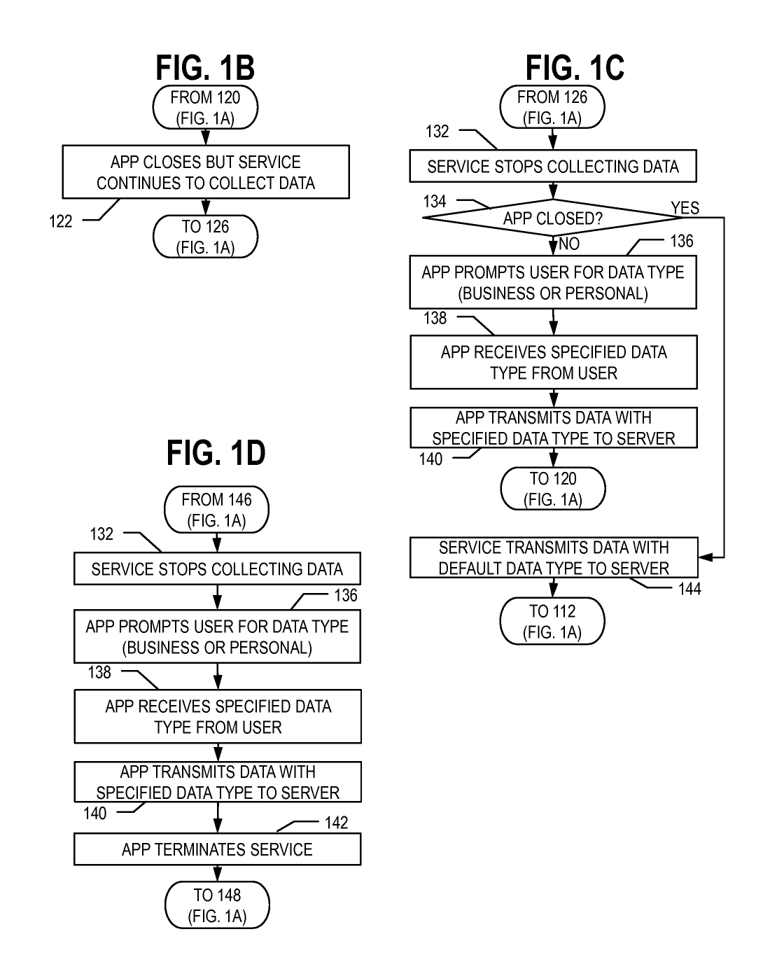

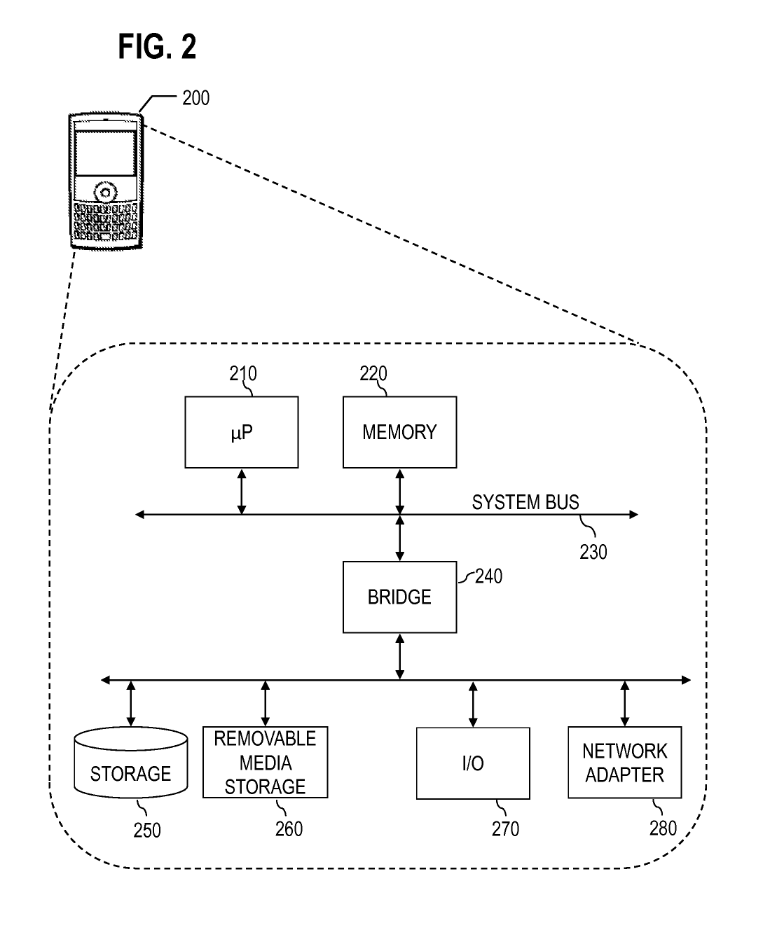

FIGS. 1A through 1D (collectively, FIG. 1) are flowcharts showing one embodiment of a process for tracking mileage using a mobile device, while FIG. 2 shows one embodiment of the mobile device and the processing components within the mobile device. The embodiment of the process as shown in FIG. 1 is preferably implemented on an Android™-based mobile device, such as a smartphone. Consequently, in a preferred embodiment, the mobile device of FIG. 2 is a smartphone with an Andriod™-based OS.

Throughout this disclosure, it should be understood that there is a distinction between a service and an application (or “app”). Specifically, an app is a software application that runs in the foreground, while a service is a software process that runs in the background. Thus, a service can run while the operator of the smartphone is performing another activity or launching another app, or the service can be configured to run at all times until terminated by the OS.

As shown in FIG. 1A, the process begins by determining 102 whether or not a mileage-tracking service is running on the smartphone. If the mileage-tracking service is running, then the service looks for a Bluetooth® connection 112 to a vehicle's onboard diagnostics (OBD). Conversely, if the mileage-tracking service is not running, then the process determines 104 whether or not a mileage-tracking app has been started by a user on the smartphone. If the mileage-tracking app has been started on the smartphone, then the process starts 110 the mileage-tracking service, which in turn looks for the Bluetooth® connection 112 to the OBD. On the other hand, if neither the mileage-tracking service nor the mileage-tracking app has been started, then the process waits until it detects 106 that a user has launched 108 the mileage-tracking app. Thereafter, the app starts 110 the service, which in turn looks for the Bluetooth® connection 112 to the OBD. At this point, it is worthwhile to note that a service is running on the smartphone. Since the service can run in the background even when other applications are launched, one can appreciate that the app simply provides a lightweight interface to launch the service, and the service can continue even when the user performs other activities with other apps.

Continuing with FIG. 1A, the mileage-tracking service determines 114 whether or not the Bluetooth® connection to the OBD is successful. If the connection is unsuccessful, then the process waits 116 a finite amount of time (designated in FIG. 1A as “M” seconds), and then looks for the Bluetooth® connection 112 again. This process of searching for the Bluetooth® connection to the OBD repeats until a connection is established. Typically, the Bluetooth® connection is established with the OBD through a Bluetooth® OBD interface, which can be purchased as an off-the-shelf product and installed in any vehicle that has an OBD.

Once the Bluetooth® connection to the OBD is established, the mileage-tracking service collects 118 data. During the data collection 118, the process also determines whether or not one (1) of four (4) events occurs, namely: (a) whether or not the app is interrupted 120 by the OS; (b) whether or not the service loses 126 the Bluetooth® connection; (c) whether or not the user terminates 130 the data collection process (e.g., user indicates that the trip is completed); or (d) whether or not the user terminates 146 the system (e.g., user manually shuts down the service or powers down the mobile device). Processes associated with each of these four (4) events are described in turn.

If the service determines 120 that the app is interrupted by the OS, then the process continues to FIG. 1B, where the OS closes 122 the app but continues to collect data. It should be appreciated that the app can be interrupted by an incoming telephone call, the user choosing to place an outgoing telephone call, the user launching another app, the user selecting a “home” icon (such as those on Android™-based smartphones), or the user selecting a “back” icon.

Next, if the service determines 126 that the Bluetooth® connection is lost, then the process continues to FIG. 1C, where the service stops 132 collecting data. Once the service stops 132 collecting data, the process determines 134 whether or not the app is closed. Recalling from the description of FIG. 1A, above, the app may be closed 122 by a specific interrupt (e.g., an OS-initiated interrupt due to an incoming telephone call, etc.). Consequently, when the service stops 132 collecting data, the app may either be open (not interrupted but data collection stopped) or closed (app interrupted, thereby closing the app).

If the app has not been closed, then the app prompts 136 the user for a mileage data type, such as, for example, whether the collected mileage data is for business travel or for personal travel. The app then receives 138 the specified data type from the user and transmits 140 the data (e.g., mileage, total odometer reading, miles traveled since engine start, user identification, date, time, etc.) with the specified data type (e.g., personal or business) to a server. For some embodiments, a database at the server is populated through known interfaces, such as, for example, an Amazon® AWS Android™ interface. Upon transmitting 140 the data to the server, the process returns to FIG. 1A.

If, as shown in FIG. 1C, the process determines 134 that the app has been closed, then the service transmits 144 the data with a default data type (e.g., unspecified) to the server. To be clear, the service transmits 144 the data because the app has been closed 122 due to some type of OS-initiated interrupt. Consequently, the user has been unable to enter a data type due to the app closure. Thus, by designating the mileage data type to be a default data type, such as “unspecified,” the user can later access the data from the server and properly categorize the mileage data as being for either personal travel or business travel. Once the service transmits 144 the data, the process returns to FIG. 1A.

Continuing with FIG. 1A, if the service determines 130 that the user has terminated data collection, then the service once again proceeds to FIG. 1C, as described above. For some embodiments, the termination of data collection can be initiated by the user indicating that the trip has been completed.

Next, as shown in FIG. 1A, if the service determines 146 that the user has terminated the system, then the process continues to FIG. 1D, where the service stops 132 collecting data. Thereafter, the app prompts 136 the user for a mileage data type, such as, for example, whether the collected mileage data is for business travel or for personal travel. The app then receives 138 the specified data type from the user and transmits 140 the data with the specified data type to the server. Upon transmitting 140 the data to the server, the app then terminates 142 the service.

So far, as seen in the embodiment of FIG. 1, either the mileage-tracking service or the mileage-tracking app continues to collect data until one (1) of four (4) events occurs, namely: (a) app interruption; (b) lost Bluetooth® connection; (c) user-termination of the data collection; or (d) user-termination of the system. Absent one of these four (4) conditions, data collection 118 continues.

Continuing with FIG. 1A, the process next determines 148 whether or not the service needs to be restarted. For example, if the app has terminated 142 the service, as shown in FIG. 1D, then the user has the option of restarting the service. If the user chooses to restart the service, then the app starts 110 the service and the process repeats. Conversely, if the user does not restart the service, then the app terminates 150 and the process ends.

As described above, to the extent that the smartphone is not shut down (or powered down) and the service continues, mileage data continues to be collected. However, if the user powers down (or shuts down) the smartphone, then all apps and services, including the mileage-tracking app and the mileage-tracking services described above, are terminated 150, and the process ends until the smartphone is once again powered up (or turned on).

It should be noted that, for the actual mileage calculation, the mileage-tracking service maintains a wireless Bluetooth® connection with the OBD. Preferably, the service sends a message to the OBD over the Bluetooth® wireless interface every second (or at other designated intervals) to obtain the RPM data and the vehicle speed data. The obtained RPM and speed data can be displayed on the app to inform the user that the app is running. For some embodiments, the actual mileage is calculated based on the vehicle speed and the sampling rate or the elapsed time. The mileage-tracking service maintains a running tally of total accumulated miles. By way of example, if the vehicle speed (in miles-per-hour (MPH)) is obtained from the OBD at every two (2) seconds, then the mileage can be calculated as vehicle speed divided by 1800 samples per hour. By continuing to accumulate the distance traveled for each sampling interval, the total mileage can be tracked. Since the OBD data can be used in various combinations to obtain the total actual mileage for any given period, further discussion of the actual calculation method is omitted here.

As shown through the process of FIG. 1, by spawning a service that runs in the background, the disclosed mileage-tracking process does not suffer from other mileage-tracking apps that terminate and lose data when the app is interrupted by, for example, an incoming telephone call. In other words, the disclosed process implements a mileage-tracking service (in the background) that is comparatively immune to interruptions by the OS, unlike conventional foreground applications that are susceptible to OS-initiated interruptions.

FIG. 2 is a block diagram showing one embodiment of a data processing system of an embodiment of a mobile device. Mobile device 200 includes one or more processors 210 connected to memory 220 across a system bus 230. A bus bridge 240 is connected to the system bus 230 and provides an interface to any number of peripherals, such as storage 250 (e.g., internal hard drives), removable media storage 260 (e.g., removable memory cards, etc.), input/output (“I/O”) 270 (e.g., keyboard, touchpad, etc.), a network adapter 280 or combinations thereof.

The memory 220, storage 250, removable media storage 260, or combinations thereof can be used to implement a computer usable storage medium having computer usable program code embodied thereon. The computer usable program code may be executed to implement any aspect of the present invention, for example, to implement any aspect of any of the methods and/or system components illustrated in the FIG. 1.

The mileage-tracking mobile application (“app”) and the service that the app launches may be implemented in hardware, software, firmware, or a combination thereof. In the preferred embodiment(s), the app and the service are implemented in software or firmware that is stored in a memory and that is executed by a suitable instruction execution system. If implemented in hardware, as in an alternative embodiment, the app and the service can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The app and the service, when implemented as a software program, comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. Any combination of one or more computer-readable medium(s) may be utilized. The computer-readable medium may be a computer-readable signal medium or a computer-readable storage medium. A computer-readable storage medium includes, for example, but not limited to, a hard disk, solid state drive, a random access memory (RAM), a read-only memory (ROM), an erasable programmable read-only memory (EPROM), Flash memory, an optical storage device (e.g., CD-ROM), a magnetic storage device, or any suitable combination of the foregoing or other storage hardware. Thus, a computer-readable storage medium includes any tangible medium that can contain, or store a program for use by or in connection with an instruction execution system, apparatus, or device.

A computer-readable signal medium is a propagated data signal with computer-readable program code embodied therein, for example, in baseband or as part of a carrier wave. A computer-readable signal medium may be any computer-readable medium that is not a computer-readable storage medium and that can communicate, propagate, or transport a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. For example, while Bluetooth® connections are specifically described with reference to the embodiment of FIG. 1, it should be appreciated that other protocols for accessing the OBD can be implemented. For example, the OBD may be accessed using cellular radio, a universal serial bus (“USB”) connection, or other type of data connection that is compatible with a vehicle's OBD. Thus, the description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

1. A mileage-tracking method, comprising:
launching a mileage-tracking application on a smartphone, the mileage-tracking application running as a foreground process, the mileage-tracking application being launched in response to a user-initiated command;
starting a mileage-tracking service through the launched mileage-tracking application, the mileage-tracking service running as a background process;
establishing a Bluetooth® wireless connection to a vehicle onboard diagnostics (OBD), the Bluetooth® wireless connection being established using the mileage-tracking service;
collecting vehicle mileage data through the established connection, the vehicle mileage data being collected by the mileage-tracking service even when the mileage-tracking application is closed;
querying a user for mileage data type;
receiving the mileage data type from the user; and
populating a database with the received mileage data type.

2. Computer readable storage hardware with a program stored thereon, the program instructing a processor to perform:
launching a mileage-tracking application, the mileage-tracking application running as a foreground process;
starting a mileage-tracking service through the launched mileage-tracking application, the mileage-tracking service running as a background process;
establishing a connection with a vehicle onboard diagnostics (OBD) through the mileage-tracking service; and
collecting vehicle mileage data through the established connection, the vehicle mileage data being collected by the mileage-tracking service even when the mileage-tracking application is closed.

3. The computer-readable storage hardware of claim 2, the program further instructing the processor to perform:
establishing a Bluetooth® wireless connection with the OBD.

4. The computer-readable storage hardware of claim 2, the program further instructing the processor to perform:
establishing a wireless cellular connection with the OBD.

5. The computer-readable storage hardware of claim 2, the program further instructing the processor to perform:
establishing a connection with the OBD through a universal serial bus (USB).

6. The computer-readable storage hardware of claim 2, the program further instructing the processor to perform:
determining whether a mobile operating system (OS) interrupts the mileage-tracking application;
closing the mileage-tracking application in response determining that the mobile OS interrupting the mileage-tracking application; and
continuing to collect vehicle mileage data after the mileage-tracking application has been closed, the vehicle mileage data being collected by the mileage-tracking service.

7. The computer-readable storage hardware of claim 2, the program further instructing the processor to perform:
determining whether the mileage-tracking application has been closed; and
populating a database with a default data type in response to determining that the mileage-tracking application has been closed, the database comprising the vehicle mileage data.

8. The computer-readable storage hardware of claim 2, the program further instructing the processor to perform:
determining whether the mileage-tracking application has been closed;
querying a user for a data type in response to determining that the mileage-tracking application has not been closed;
receiving the data type from the user; and
populating a database with the received data type, the database comprising the vehicle mileage data.

9. A method, comprising:
launching a mileage-tracking application, the mileage-tracking application running as a foreground process;
starting a mileage-tracking service through the launched mileage-tracking application, the mileage-tracking service running as a background process;
establishing a connection with a vehicle onboard diagnostics (OBD) through the mileage-tracking service; and
collecting vehicle mileage data through the established connection, the vehicle mileage data being collected by the mileage-tracking service even when the mileage-tracking application is closed.

10. The method of claim 9, establishing the connection with the vehicle onboard diagnostics (OBD) comprising:
establishing a Bluetooth® wireless connection with the OBD.

11. The method of claim 9, establishing the connection with the vehicle onboard diagnostics (OBD) comprising:
establishing a wireless cellular connection with the OBD.

12. The method of claim 9, establishing the connection with the vehicle onboard diagnostics (OBD) comprising:
establishing a connection with the OBD through a universal serial bus (USB).

13. The method of claim 9, further comprising:
determining whether a mobile operating system (OS) interrupts the mileage-tracking application;
closing the mileage-tracking application in response determining that the mobile OS interrupting the mileage-tracking application; and
continuing to collect vehicle mileage data after the mileage-tracking application has been closed, the vehicle mileage data being collected by the mileage-tracking service.

14. The method of claim 9, further comprising:
determining whether the mileage-tracking application has been closed; and
populating a database with a default data type in response to determining that the mileage-tracking application has been closed, the database comprising the vehicle mileage data.

15. The method of claim 9, further comprising:
determining whether the mileage-tracking application has been closed;
querying a user for a data type in response to determining that the mileage-tracking application has not been closed;
receiving the data type from the user; and
populating a database with the received data type, the database comprising the vehicle mileage data.

16. The method of claim 9, further comprising:
obtaining mile-per-hour (mph) data from the OBD.

17. The method of claim 16, further comprising:
calculating a total mileage using the obtained mph data.

18. The method of claim 9, further comprising:
obtaining vehicle speed data from the OBD.

19. The method of claim 18, further comprising:
calculating a total mileage using the obtained vehicle speed data.

20. The method of claim 9, further comprising:
calculating a total mileage using the collected vehicle mileage data.
